(19) United States
(12) Patent Application Publication
(10) Pub. No.: US 2023/0313511 A1
(43) Pub. Date: Oct. 5, 2023

(54) Shower Head Hanger

(71) Applicant: LC US CORPORATION, Buena Park, CA (US)

(72) Inventor: Wei-Ta Chiang, Buena Park, CA (US)

(73) Assignee: LC US CORPORATION, Buena Park, CA (US)

(21) Appl. No.: 17/706,697

(22) Filed: Mar. 29, 2022

(51) Int. Cl. E03C 1/06; A47K 3/28; B05B 15/62

(52) U.S. Cl. CPC E03C 1/06; A47K 3/281; B05B 15/62

(57) ABSTRACT

The present invention relates to a shower head hanger comprising a framework and at least one placement basket, where the framework is formed by bending a hollow tube body, a top of the framework is provided with a ring sleeve enabled to be clamped to a shower head fixing seat set on a wall for fixing, the placement basket has a frame and a carrying surface, both sides of one end of the frame are kept horizontal and secured, respectively, on both sides of the framework, the carrying surface is connected below the frame and formed by bending one bar-shaped piece. By using the framework, the present invention realizes easy fixation on the wall and bathroom space saving, and then various bathroom items are placed in the placement basket for convenient access and operation of personnel.

### BACKGROUND OF THE INVENTION

### 1. Field of the Invention

The invention belongs to bathroom articles, in particular to a shower head hanger installed on a shower head fixing seat to facilitate arrangement of bathroom items

### 2. Description of the Prior Art

Bathrooms are one of the most commonly used places in life. It is provided with cleaning-related equipment for body cleaning and other washing tasks. Shower heads are quite common among them, which allow a user to direct water to rinse each part of the body to achieve the purpose of cleaning. Since shower heads are basic equipment of bathrooms, a special fixing seat is usually set on the bathroom wall to facilitate the operation of personnel and maintain the cleanliness of the bathroom.

In addition to basic equipment, bathrooms will also be equipped with different items according to personnel needs, such as products related to teeth-brushing, face-washing, and showering. However, most of these products are consumable items and do not have a fixed place for placement. Therefore, they are easy to be placed arbitrarily according to usage habits of personnel, resulting in disorganized furnishings in bathrooms.

However, due to the need for continuous water use, bathrooms are often in a humid environment. If bathroom items are scattered around, not only pests or bacteria will be easily bred, which affect health of personnel, but also accidents that people slip and fall due to stepping on objects may happen, affecting safety of life.

For this reason, there is still a need for a good place, such as commodity shelves, for non-fixed bathroom items. However, common commodity shelves in the market need to occupy the limited space of bathrooms and are prone to hide dirt, so there is still room for improvement in their design.

### SUMMARY OF THE INVENTION

The objective of the present invention is to provide a shower head hanger, which is hung on the wall by making use of a shower head fixing seat to save space. Not only it can be easily set up to effectively organize bathroom items and maintain the cleanliness of bathroom environment, but also it can improve environmental hygiene and reduce occurrence of accidents.

Another objective of the present invention is to provide a shower head hanger, which has a light and strong structure, can be easily cleaned to maintain hygiene, and can be used for long term to save resources.

In order to achieve the above objectives, the technical solution adopted in the present invention is to provide a shower head hanger, which includes a framework and at least one placement basket.

The framework is formed by bending a hollow tube body, a top of the framework being provided with a ring sleeve enabled to be clamped to a shower head fixing seat set on a wall for fixing.

The placement basket has a frame and a carrying surface. Both sides of one end of the frame are kept horizontal and are secured on both sides of the framework respectively. The carrying surface is connected below the frame and is formed by bending a bar-shaped piece.

In the aforementioned design, the framework is formed by bending and assembling a plurality of sections of the hollow tube bodies, junctions of each of the hollow tube bodies being secured with screws or fasteners.

In addition, the bottom of the framework is bent forward to be arranged horizontal to the ground.

Moreover, the framework is provided with a fixing frame, on which two clamping rings are formed by bending, each of the clamping rings being equipped, respectively, with a suction cup in a detachable manner.

Also, a buckle clip is arranged outside the ring sleeve. The inner side of the buckle clip is provided with clamp teeth enabled to engage with the shower head fixing seat to stabilize a position of the framework.

In the aforementioned design, the frame of the placement basket is secured to the frame with screws or fasteners.

In addition, the periphery of the carrying surface of the placement basket is bent upwards to form a retaining rib.

Moreover, the carrying surface of the placement basket is bent by the bar-shaped piece to form a plurality of placement areas with different heights and ranges.

Further, the carrying surface of the placement basket is formed by bending and assembling a plurality of the bar-shaped pieces, each of the bar-shaped pieces being secured to each other by welding, sticking, nails, screws or fastener; wherein, the edge of each of the bar-shaped pieces is bent upwards to form a hook.

### BRIEF DESCRIPTION OF THE DRAWINGS

FIG. 1 is an exploded perspective view of the present invention;

FIG. 2 is a three-dimensional combined view of the present invention; and

FIG. 3 is a diagram of an embodiment of the present invention positioned on a shower head hanger.

### DESCRIPTION OF MAIN COMPONENT SYMBOLS

100: Shower head hanger
110: Framework
111: Hollow tube body
112: Ring sleeve
113: Bottom
114: Fixing frame
115: Clamping ring
120: Placement basket
121: Frame
122: Carrying surface
123: Bar-shaped piece
124: Retaining rib
125: Placement area
126: Hook
130: Screws or Fasteners
140: Suction Cup
150: Buckle clip
151: Clamp teeth
200: Shower head fixing seat
210: Shower head

### DETAILED DESCRIPTION OF THE PREFERRED EMBODIMENT

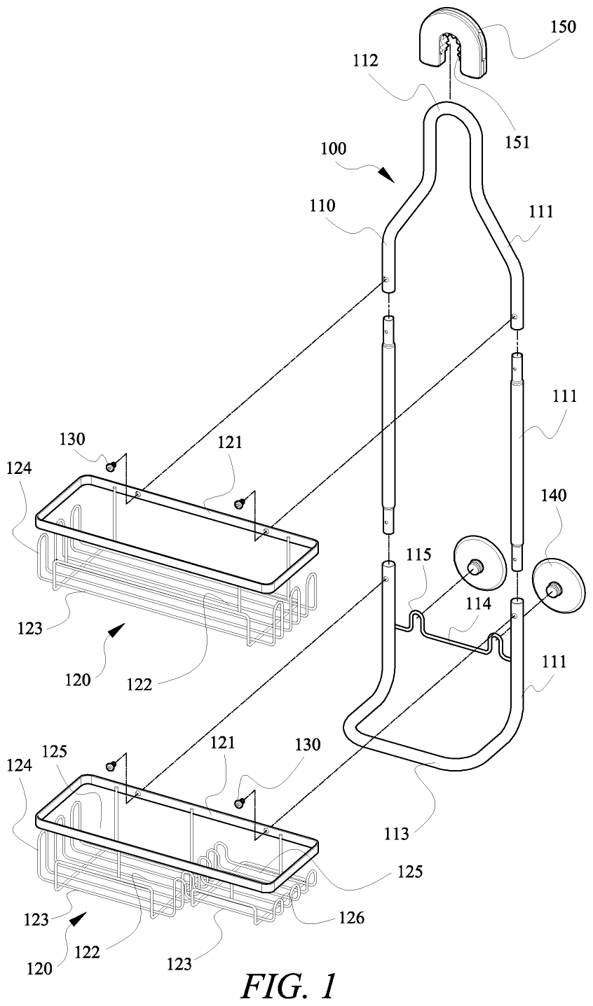

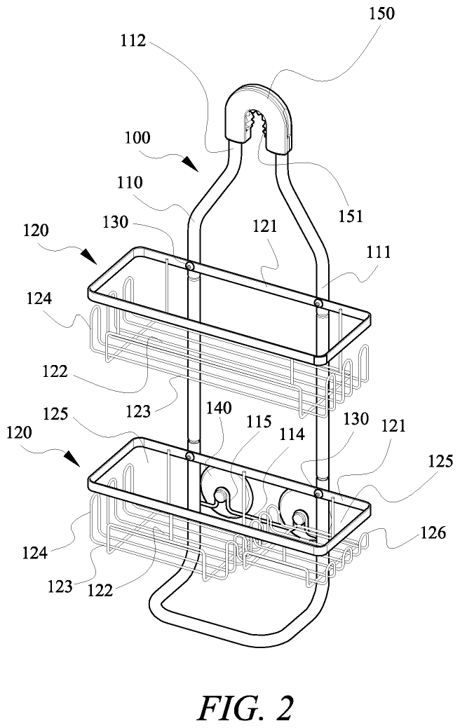

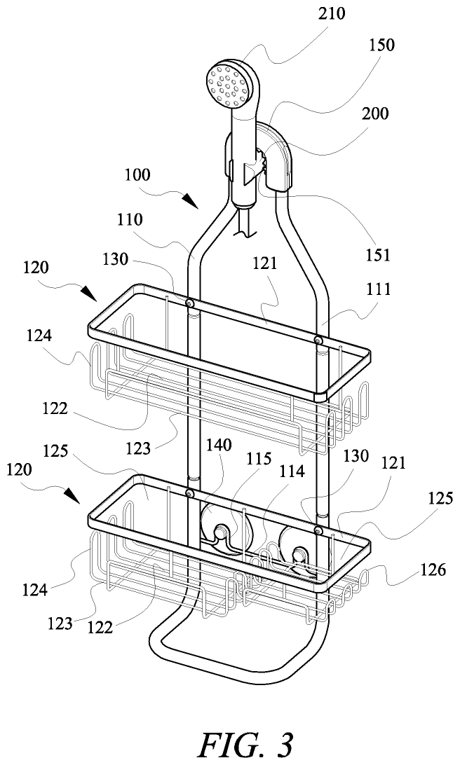

With reference to FIG. 1 to FIG. 3, a shower head hanger 100 provided by the present invention is shown, which is fixed on a shower head fixing seat 200. The shower head fixing seat 200 is used for placing a shower head 210, and is arranged on a wall of a bathroom (not shown in the figure).

The abovementioned shower head hanger 100 comprises a framework 110 and at least one placement basket 120.

The framework 110 is formed by bending a hollow tube body 111, which is mostly a rust-proof metal tube, so that it is overall light in weight and strong; a ring sleeve 112 is provided on the top of said framework 110, the ring sleeve 112 being enabled to be clamped on the shower head fixing seat 200 to thereby be fixed on the wall.

The placement basket 120 has a frame 121 and a carrying surface 122. Both sides of one end of the frame 121 are kept horizontal and fixed to both sides of the framework 110, respectively. The carrying surface 122 is connected below the frame 121 for carrying bathroom items (not shown in the figure). The carrying surface 122 is formed by bending a bar-shaped piece 123, such as a metal bar, so that it is lightweight and will not accumulate water or stick to dirt.

Through the composition of the aforementioned structure, the present invention can be easily hung on the shower head fixing seat 200 by means of the framework 110 and thereby be fixed on the wall, saving bathroom space. Various said bathroom articles can then be placed in the placement basket 120 for convenient access and operation by personnel. The framework 110 can be easily removed for cleaning or arranging, so as to maintain the tidiness of the bathroom.

In the aforementioned structure of the framework 110, the framework 110 can be formed by bending a plurality of sections of the hollow tube bodies 111 respectively and then assembling them together, so that the length and volume of each hollow tube body 111 can be reduced when disassembled, convenient for carrying or placement. When assembled, junctions of the hollow tube bodies 111 are secured with screws or fasteners 130.

In addition, the framework 110 as a whole presents a closed ring body without sharp edges, which reduces accidents of injury to the personnel. A bottom 113 of the framework 110 is bent forwards to be arranged horizontal with the ground. The bending of the bottom 113, on the one hand, can increase structural strength, and can also enable temporary placement on the ground for easy operation.

Moreover, the framework 110 is provided with a fixing frame 114, on which two clamping rings 115 are formed by bending. Two suction cups 140 mating with the two clamping rings 115 are arranged, so that a tail of each suction cup 140 is embedded in the corresponding clamp ring 115 to form a detachable structure. Adhering to the wall is achieved by means of each of the suction cups 140, so as to obtain better support.

Also, a buckle clip 150 is provided on the outside of the ring sleeve 112, the inner side of the buckle clip 150 being provided with clamp teeth 151 enabled to engage with the shower head fixing seat 200, which can strengthen the effect of stabilizing a position of the framework 110.

In the aforementioned structure of the placement basket 120, the frame 121 of the placement basket 120 is also secured to the framework 110 by screws or fasteners. In this embodiment, the screws or fasteners 130 used in the assembly of the framework 110 are also used here to maintain overall simplicity.

In addition, periphery of the carrying surface 122 of the placement basket 120 is bent upwards to form a retaining rib 124 to block the bathroom items from slipping off.

Furthermore, when the present invention is in practical use, two placement baskets 120 (an upper one and a lower one) are simultaneously disposed on the framework 110, the two placement baskets 120 having different said carrying surfaces 122. For example, below this embodiment the carrying surface 122 of the placement basket 120 is planned with different placement areas 125 to facilitate classification and placement of different bathroom items. The plurality of placement areas 125 are also formed by bending the bar-shaped pieces 123, whereby the placement areas 125 of different heights and ranges can be formed.

In order to match the planning of the placement areas 125 below, the carrying surface 122 of the placement basket 120 can also be formed by bending a plurality of the bar-shaped pieces 123 respectively and then assembling them together. Each of the bar-shaped pieces 123 are secured to each other by welding, sticking, nails, screws or fastener.

Additionally, in addition to necessary arrangements for the retaining rib 124, a part of the edge of each of the bar-shaped pieces 123 can be bent upwards to form a hook 126, so as to facilitate placement of hookable bathroom articles.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A shower head hanger, comprising:
a framework formed by bending a hollow tube body, a top of the framework being provided with a ring sleeve enabled to be clamped on a shower head fixing seat set on a wall for fixing;
at least one placement basket having a frame, both sides of one end of the frame being horizontal and fixed on both sides of the framework respectively, wherein a carrying surface formed by bending one bar-shaped piece is connected below the frame.

2. The shower head hanger of claim 1, wherein the framework is formed by bending and assembling a plurality of sections of the hollow tube bodies, junctions of each of the hollow tube bodies being secured with screws or fasteners.

3. The shower head hanger of claim 1, wherein a bottom of the framework is bent forwards to be arranged horizontally with the ground.

4. The shower head hanger of claim 1, wherein the framework is provided with a fixing frame, on which two clamping rings are formed by bending, each of the clamping rings being equipped, respectively, with a suction cup in a detachable manner.

5. The shower head hanger of claim 1, wherein a buckle clip is arranged outside the ring sleeve, an inner side of the buckle clip being provided with clamp teeth enabled to engage with the shower head fixing seat to stabilize a position of the framework.

6. The shower head hanger of claim 1, wherein the frame of the placement basket is secured to the frame with screws or fasteners.

7. The shower head hanger of claim 1, wherein a periphery of the carrying surface of the placement basket is bent upwards to form a retaining rib.

8. The shower head hanger of claim 1, wherein the carrying surface of the placement basket is bent by the bar-shaped piece to form a plurality of placement areas with different heights and ranges.

9. The shower head hanger of claim 1, wherein, the carrying surface of the placement basket is formed by bending and assembling a plurality of the bar-shaped pieces, each of the bar-shaped pieces being secured to each other by welding, sticking, nails, screws or fasteners.

10. The shower head hanger of claim 9, wherein an edge of each of the bar-shaped pieces is bent upwards to form a hook.
